(19) United States
(12) Patent Application Publication
(10) Pub. No.: US 2004/0090685 A1
(43) Pub. Date: May 13, 2004

(54) Lens assembly

(76) Inventor: Jones Chen, Taichung (TW)

Correspondence Address: BACON & THOMAS, PLLC, 625 SLATERS LANE, FOURTH FLOOR, ALEXANDRIA, VA, 22314

(21) Appl. No.: 10/404,130

(22) Filed: Apr. 2, 2003

(30) Foreign Application Priority Data
Nov. 8, 2002 (CN) 02258384.X

(51) Int. Cl. G02B 9/12

(52) U.S. Cl. 359/784

(57) ABSTRACT

A lens assembly includes an aperture and a lens unit. The lens unit includes a first lens, a second lens, and a third lens in sequence from an object side toward an image side. The first lens is a positive lens having a concave surface that faces the image side. The second lens is a meniscus lens having a concave surface that faces the first lens and a convex surface that faces the third lens. The third lens is a non-spherical lens having two wavelike surfaces in the formation of concavity-convexity-concavity or convexity-concavity-convexity and being symmetrically formed with respect to an optical axis. The aperture is disposed behind the first lens. A coverage angle of the lens unit is ranged between 60° and 70°. Accordingly, the arrangement of the lens assembly greatly reduces the optical distortion to improve the image quality.

### BACKGROUND OF THE INVENTION

1. Field of the Invention

The present invention relates generally to optical lenses, and more particularly to a lens assembly for use in a mobile phone having an image-capturing function.

2. Description of the Related Art

As the technology of the multimedia enhances, a variety of state-of-the-art multimedia instruments, such as digital cameras, hand-held or pocketable PC (personal computer) cameras, and especially mobile phones, had been invented and have been further equipped with an image pickup device, like charge-coupled device (CCD) or complementary metal-oxide semiconductor (CMOS), for capturing images. Accordingly, those mobile phones can be further used for shooting and storing images, and sending images and e-mails, thereby facilitating regular human life.

In order to enable those small mobile phones to be capable of capturing images as the digital cameras, the dimension of lenses mounted in the mobile phone must be miniature, and the quality of images that are taken by the image pickup device cannot be worse than the usual digital cameras. According to the design of the conventional digital cameras, the last lens of a lens unit must be either convex or concave. If the above design is applied in the mobile phone which has a limit assembly space for the lens unit, the lens unit will probably be too short to form an image.

### SUMMARY OF THE INVENTION

The primary objective of the present invention is to provide a lens assembly, which is structurally miniature and compact so as to be appropriately used in a camera lens system of a mobile phone. The arrangement of the lens assembly greatly reduces the optical distortion so as to improve the image quality.

The foregoing objective of the present invention is attained by the lens assembly, which is composed of an aperture and a lens unit. The lens unit includes a first lens, a second lens, and a third lens in sequence from an object side toward an image side. The first lens is a positive lens disposed at the front side of the lens assembly and having a concave surface that faces the image side. The second lens is a meniscus lens disposed behind the first lens and having a concave surface that faces the first lens and a convex surface that faces the third lens. The third lens is a non-spherical lens having two wavelike surfaces in the formation of concavity-convexity-concavity or convexity-concavity-convexity and being symmetrically formed with respect to an optical axis. The aperture is disposed behind the first lens. The first lens is coated with an infrared-cut film on the concave surface. A coverage angle of the lens unit is ranged between 60° and 70°. Accordingly, the arrangement of the lens assembly greatly reduces the optical distortion to improve the image quality.

In addition, the lens unit of the present invention is formed of a regular glass lens and plastic resin lenses designed of non-sphere so as to be high-quality, low-cost, miniature, and lightweight, thereby generating high-quality images for the mobile phone.

### BRIEF DESCRIPTION OF THE DRAWINGS

FIG. 1 is a sectional view of a preferred embodiment of the present invention mounted in a camera lens.

FIG. 2 is a schematic view, showing that optical paths travel through a lens unit of the preferred embodiment of the present invention.

### DETAILED DESCRIPTION OF THE INVENTION

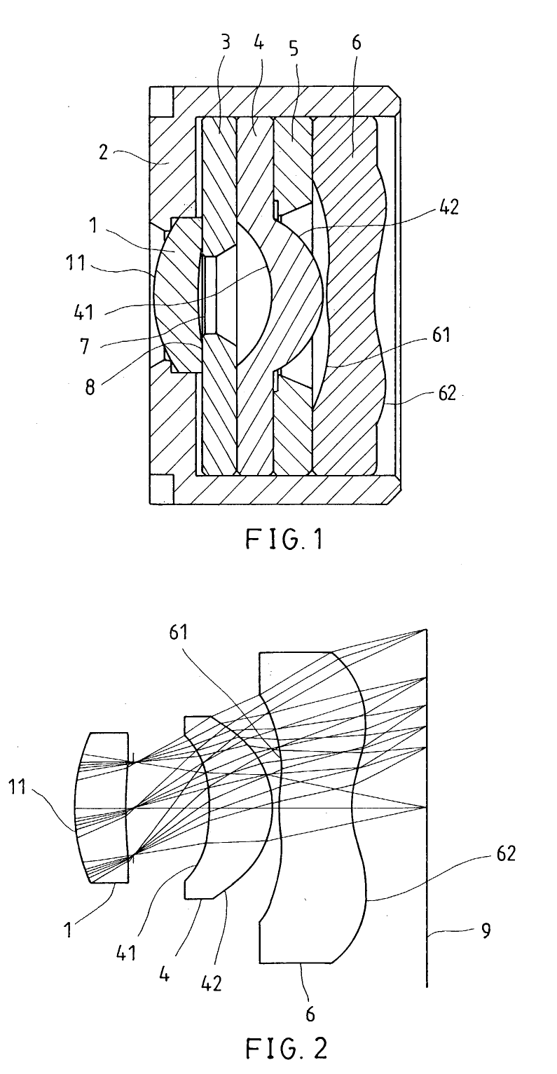

Referring to FIGS. 1-2, a lens assembly of a preferred embodiment of the present invention is composed of a lens unit and an aperture. The lens unit is formed of a first lens 1, a second lens 4, and a third lens 6 in sequence from the object side, i.e. left side of the drawings, toward the image side 9, i.e. right side of the drawings. The first lens 1 is a positive lens made of glass and includes a concave surface facing the image side 9 and being coated with an infrared-cut film 8 for reducing the infrared interference, and a convex surface. The index of infraction of the first lens 1 is ranged between 1.55 and 1.90. The second lens 4 is a meniscus lens having a concave surface that faces the first lens 1 and a convex surface that faces the third lens 6. The third lens 6 is a non-spherical lens having two wavelike surfaces in the formation of concavity-convexity-concavity or convexity-concavity-convexity and being symmetrically formed with respect to an optical axis of the lens unit. The second lens 4 and the third lens 6 are made of resin. The three lenses are respectively mounted fixedly on a barrel 2. The aperture 7 is mounted between the first lens 1 and the second meniscus lens 4. Two spacers 3 and 5 are respectively mounted between the first and second lenses 1 and 4 and between the second and third lenses 4 and 6.

The ratio of the total length of the lens unit to the total focal length of the lens unit is constructed under a condition as described hereunder:

1<TL/f<1.5

Wherein, TL is the distance between the convex surface of the first lens and the image side 9, and f is the total focal length of the lens unit.

The second lens 4 and the third lens 6, each of which is symmetrically formed with respect to the optical axis, are non-spherical lenses constructed under a non-spherical formula as described hereunder:

Z=cr²/1+[1−(1+k)c²r²]^{1/2}+Ar²+Br⁴+Cr⁶+Dr⁸+Er¹⁰+Fr¹²

Wherein, Z is a value of a Z-axis along the optical axis, k is a taper constant, c=1/k, r is an aperture diameter, and A, B, C, D, E, and F are high order non-spherical coefficients.

The second lens 4 includes a concave surface 41 facing the first lens 1 and a convex surface 42 facing the third lens 6. The third lens 6 includes a concavity-convexity-concavity surface 61 facing the second lens 4 and a convexity-concavity-convexity surface 62 facing the image side 9. The concave surface 41, the convex surface 42, the concavity-convexity-concavity surface 61, and the convexity-concavity-convexity surface 62 are non-spherical and are respectively formed symmetrically with respect to the optical axis. The best parameters of the non-spherical formulas for the above four surfaces are described in the following four tables.

The parameters of the non-spherical formula for the concave surface 41 of the second lens 4 are given hereunder:

| CURV | 1/r = −0.2840700124 |
|---|---|
| K | 1.484206 |
| A | −0.037567701 |
| B | −0.021541526 |
| C | −0.18422002 |
| D | 0.041987247 |
| E | 0.059508229 |
| F | −0.022822562 |
| r | −3.510373 |

The parameters of the non-spherical formula for the convex surface 42 of the second lens 4 are given hereunder:

| CURV | 1/r = −0.5183668949 |
|---|---|
| K | −0.2025153 |
| A | −0.0150071 |
| B | −0.37844612 |
| C | 0.35196676 |
| D | −0.20823227 |
| E | 0.052150968 |
| F | 0.00057939948 |
| r | −1.925347 |

The parameters of the non-spherical formula for the concavity-convexity-concavity surface 61 of the third lens 6 are given hereunder:

| CURV | 1/r = 0.4766426057 |
|---|---|
| K | −0.7493171 |
| A | −0.028225447 |
| B | −0.47119421 |
| C | 0.28958559 |
| D | −0.080834605 |
| E | 0.0080859552 |
| F | −0.00017295993 |
| r | 2.098008 |

The parameters of the non-spherical formula for the convexity-concavity-convexity surface 62 of the third lens 6 are given hereunder:

| CURV | 1/r = 0.7143022531 |
|---|---|
| K | −2.676218 |
| A | −0.0055540253 |
| B | −0.1497527 |
| C | 0.0433 10223 |
| D | −0.0066530137 |
| E | 0.00038612224 |
| F | −1.1489854e-005 |
| r | 1.39985 |

In conclusion, while the beam travels from the convex surface 11 of the first lens 1 through the convexity-concavity-convexity surface 62 of the third lens 6, the fringy main beam angle is the smallest such that an image pickup device like CCD or CMOS is provided with sufficient light so as to generate high-quality images.

What is claimed is:

1. A lens assembly comprising:
a lens unit including a first lens, a second lens, and third lens in sequence from an object side toward an image side, said first lens being a positive lens having a convex surface and a concave surface that faces the image side, said second lens being a meniscus lens having a convex surface that faces the third lens and a concave surface that faces the first lens, said third lens being a non-spherical lens having two wavelike surfaces in the formation of convexity-concavity-convexity or concavity-convexity-concavity and being symmetrically formed with respect to an optical axis of the lens unit; and
an aperture mounted behind the first lens.

2. The lens assembly as defined in claim 1, wherein said first lens comprises an infrared-cut film coated on the concave surface thereof.

3. The lens assembly as defined in claim 1, wherein said first lens has an index of refraction of between 1.55 and 1.9.

4. The lens assembly as defined in claim 1, wherein at least one of the convex and concave surfaces of the second lens is a non-spherical surface.

5. The lens assembly as defined in claim 1, wherein said lens unit comprises a coverage angle ranged between 60° and 70°.

6. The lens assembly as defined in claim 1, wherein the ratio of the total length of the lens unit to the total focal length of the lens unit is constructed under a condition as described hereunder:
1<TL/f<1.5
wherein, TL is the distance between said convex surface of the first lens and the image side, and f is the total focal length of the lens unit.
